(19) United States
(12) Patent Application Publication
(10) Pub. No.: US 2007/0288667 A1
(43) Pub. Date: Dec. 13, 2007

(54) Removable Media Device and Data Control Method

(75) Inventors: Megumi KAMATA, Nagoya-shi (JP); Fumitoshi UNO, Okazaki-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/686,508

(22) Filed: Mar. 15, 2007

(30) Foreign Application Priority Data
Mar. 15, 2006 (JP) 2006-071500

(51) Int. Cl. G06F 13/38; G06F 13/12

(52) U.S. Cl. 710/65

(57) ABSTRACT

An image displaying system includes: a removable media device and an image processor. The removable media device includes: a filename receiving unit; a reduced data determining unit; a reduced data generating unit; and a data transmitting unit. The filename receiving unit receives a filename of an image file stored on removable medium from the image processor. The reduced data determining unit determines whether an image file with the filename received by the filename receiving unit has reduced data in a prescribed region of the image file for displaying the image file at a reduced size when a prescribed reduced display command is attached to the filename. The reduced data generating unit generates reduced data based on the image file in order to display the image file at a reduced size when the reduced data determining unit determines that the reduced data is not included in the prescribed region of the image file. The data transmitting unit transmits either the reduced data generated by the reduced data generating unit or the reduced data included in the prescribed region of the image file to the image processor for each image file. The image processor includes a display unit displaying the reduced data for each image file.

### CROSS REFERENCE TO RELATED APPLICATION

This application claims priority from Japanese Patent Application No. 2006-71500 filed Mar. 15, 2006. The entire content of this priority application is incorporated herein by reference.

### TECHNICAL FIELD

The present invention relates to an image displaying system, an image printing system, a removable media device and a data control method.

### BACKGROUND

Japanese unexamined patent application publication No. 2000-125251 describes one display format enabling a user to easily view a plurality of image files taken on a digital camera or the like on a display screen. According to this method, the image files are reduced in size so that a plurality of images can be displayed on the display screen as thumbnail images.

Further, removable media devices, such as card readers, are used as adapters for reading image files taken with a digital camera or the like on removable medium so that the image files stored on the removable medium can be read into a personal computer for browsing by the user. More recent types of removable media devices well known in the art include a USB removable media device that communicates according to the universal serial bus (USB) communication standard, a shared folder removable media device, and a file transfer protocol (FTP) removable media device.

FIG. 1(a) is a sample screenshot of a personal computer displaying image files read from a conventional USB removable media device as thumbnail images. As shown in FIG. 1(a), image files stored on removable medium mounted in a USB removable media device and a shared folder removable media device can be displayed on the personal computer as thumbnail images.

However, image files stored on removable medium used in conventional FTP removable media devices cannot be displayed as thumbnail images. FIG. 1(b) shows the state of image files read from removable medium by a conventional FTP removable media device when displayed on a personal computer screen. As shown in FIG. 1(b), the personal computer cannot receive thumbnail images from a removable media device based on FTP and must display a prescribed icon in place of the thumbnail images.

Consequently, in order to specify image files to be browsed from among image files on a single removable medium, the personal computer must download and display the image files one at a time from the removable media device, requiring a lot of data transfers and a significant amount of time.

### SUMMARY

Printing devices equipped with a removable media device are also well known in the art. By inserting a memory card into a card slot formed in the printing device and performing key operations on the device, the user can directly print image files stored on the memory card. This type of printing device can print data from the memory card without being connected to a personal computer. However, since the display panel of the printing device is small and not suited to viewing data from the memory card in detail, consideration can be given to connecting the device to a personal computer and using the monitor of the personal computer to display image files on the memory card in order to view the image files in detail prior to printing. However, in order to display image files from the memory card on a personal computer, the image files must be transferred between the printing device and the personal computer, requiring considerable time.

Further, if the printing device and the personal computer are connected by a network using the FTP protocol, an image file on the memory card selected with a print command through user operations on the personal computer must be first read into the personal computer, thereby requiring that the image file be transferred between the printing device and the personal computer. Since these transfers of image files require time, the intended advantage of providing the printing device with an removable media device, that is, the advantage of being able to print image files from a memory card easily and quickly without passing through a personal computer, is not sufficiently demonstrated.

In view of the foregoing, it is an object of the present invention to provide an image displaying system, an image printing system, a removable media device and a data control method enabling a user to browse or print image files stored on removable medium mounted in a removable media device quickly and easily, even when using a removable media device that outputs data stored on the removable medium via a network employing FTP.

In order to attain the above and other objects, the invention provides an image displaying system, including: a removable media device that is configured to be capable of reading data stored on removable medium; and an image processor that is connected to the removable media device via a network and that is configured to be capable of displaying images based on inputted data, the image processor being capable of performing data communications with the removable media device via the network. The removable media device includes: a filename receiving unit; a reduced data determining unit; a reduced data generating unit; and a data transmitting unit. The filename receiving unit receives a filename of an image file stored on removable medium from the image processor. The reduced data determining unit determines whether an image file with the filename received by the filename receiving unit has reduced data in a prescribed region of the image file for displaying the image file at a reduced size when a prescribed reduced display command is attached to the filename. The reduced data generating unit generates reduced data based on the image file in order to display the image file at a reduced size when the reduced data determining unit determines that the reduced data is not included in the prescribed region of the image file. The data transmitting unit transmits either the reduced data generated by the reduced data generating unit or the reduced data included in the prescribed region of the image file to the image processor for each image file. The image processor includes a display unit displaying the reduced data for each image file.

According to another aspect, the invention provides an image printing system, including: a removable media device; and an image processor that is capable of data communications with the removable media device via a network. The removable media device includes: a printing unit; a filename transmitting unit; and a filename receiving unit. The printing unit is configured capable of printing an image file stored on removable medium. The filename transmitting unit transmits at least one filename of at least one image file stored on the removable medium to the image processor. The filename receiving unit receives at least one filename from the image processor that is among the at least one filename that has been transmitted to the image processor by the filename transmitting unit, the printing unit printing an image file corresponding to each of the received filename when a prescribed specification command is attached to the each filename.

According to another aspect, the invention provides a removable media device for reading data stored on removable medium. The removable media device includes: a filename receiving unit; a reduced data determining unit; a reduced data generating unit; and a data outputting unit. The filename receiving unit receives a filename of an image file stored on removable medium from the image processor. The reduced data determining unit determines whether an image file with the filename received by the filename receiving unit has reduced data in a prescribed region of the image file for displaying the image file at a reduced size when a prescribed reduced display command is attached to the filename. The reduced data generating unit generates reduced data based on the image file in order to display the image file at a reduced size when the reduced data determining unit determines that the reduced data is not included in the prescribed region of the image file. The data outputting unit outputs either the reduced data generated by the reduced data generating unit or the reduced data included in the prescribed region of the image file for each image file.

According to another aspect, the invention provides a removable media device, including: a printing unit; a filename outputting unit; and a filename receiving unit. The printing unit is configured capable of printing an image file stored on removable medium. The filename outputting unit outputs at least one filename of at least one image file stored on the removable medium. The filename receiving unit receives at least one filename that is among the at least one filename that has been outputted by the filename outputting unit, the printing unit printing an image file corresponding to each of the received filename when a prescribed specification command is attached to the each filename.

According to another aspect, the invention provides a data control method implemented on an image displaying system including an image processor and a removable media device connected with each other via a network, the image processor being capable of performing data communications with the removable media device via the network, the removable media device being capable of reading data stored on removable medium, the image processor being capable of displaying images on a screen based on data inputted from the removable media device, the data control method including: controlling the image processor to select either a reduced data request command or a simplified data request command based on user settings, the reduced data request command serving as a request for reduced data in a prescribed region of an image file in order to display the image file at a reduced size when the reduced data is included in the prescribed region and serving as a request for reduced data generated by the removable media device based on the image file when the image file does not include the reduced data, the simplified data display command serving as a request for reduced data when the reduced data is included in the prescribed region of the image file and serving as a request for prescribed icon data indicating the image file when the image file does not include the reduced data; controlling the image processor to acquire filename for each of at least one image file stored on the removable medium; controlling the image processor to transmit the acquired at least one filename after attaching the selected command to each of the acquired at least one filename; and controlling the image processor to perform either one of a first display operation and a second display operation, the first display operation being for displaying on one screen at least one reduced image for at least one image file corresponding to the transmitted at least one filename using data transmitted from the removable media device in response to the reduced data request command, the second display operation being for displaying on one screen at least one image for the at least one image file corresponding to the transmitted at least one filename using data transmitted from the removable media device in response to the simplified data request command, the image for each image file being either one of a reduced image for the corresponding image file and a prescribed icon indicating the corresponding image file.

According to another aspect, the invention provides a data control method implemented on an image printing system including an image processor and a removable media device connected with each other via a network, the image processor being capable of performing data communications with the removable media device via the network, the removable media device including a printing unit printing image files stored on removable medium, the data control method including: controlling the image processor to acquire filename for an image file stored on a removable medium; and controlling the image processor to attach a prescribed specification command to the acquired filename and to transmit the filename to the removable media device, thereby causing the removable media device to control the printing unit to print an image file corresponding to the filename to which the specification command is attached.

According to another aspect, the invention provides a data control method implemented on an image processor that is capable of displaying images on a screen based on inputted data, the data control method including: selecting either a reduced data request command or a simplified data request command based on user settings, the reduced data request command serving as a request for reduced data in a prescribed region of an image file in order to display the image file at a reduced size when the reduced data is included in the prescribed region and serving as a request for reduced data generated based on the image file when the image file does not include the reduced data, the simplified data display command serving as a request for reduced data when the reduced data is included in the prescribed region of the image file and serving as a request for prescribed icon data indicating the image file when the image file does not include the reduced data; acquiring filename for each of at least one image file stored on the removable medium; outputting the acquired at least one filename after attaching the selected command to each of the acquired at least one filename; and performing either one of a first display operation and a second display operation, the first display operation being for displaying on one screen at least one reduced image for at least one image file corresponding to the outputted at least one filename using data received in response to the reduced data request command, the second display operation being for displaying on one screen at least one image for the at least one image file corresponding to the outputted at least one filename using data received in response to the simplified data request command, the image for each image file being either one of a reduced image for the corresponding image file and a prescribed icon indicating the corresponding image file.

According to another aspect, the invention provides a data control method implemented on an image processor, the data control method including: acquiring filename for an image file stored on a removable medium; and attaching a prescribed specification command to the acquired filename and outputting the filename.

According to another aspect, the invention provides a storage medium storing a set of program instructions executable on an image processor that is capable of displaying images on a screen based on inputted data, the instructions including: selecting either a reduced data request command or a simplified data request command based on user settings, the reduced data request command serving as a request for reduced data in a prescribed region of an image file in order to display the image file at a reduced size when the reduced data is included in the prescribed region and serving as a request for reduced data generated based on the image file when the image file does not include the reduced data, the simplified data display command serving as a request for reduced data when the reduced data is included in the prescribed region of the image file and serving as a request for prescribed icon data indicating the image file when the image file does not include the reduced data; acquiring filename for each of at least one image file stored on the removable medium; outputting the acquired at least one filename after attaching the selected command to each of the acquired at least one filename; and performing either one of a first display operation and a second display operation, the first display operation being for displaying on one screen at least one reduced image for at least one image file corresponding to the outputted at least one filename using data received in response to the reduced data request command, the second display operation being for displaying on one screen at least one image for the at least one image file corresponding to the outputted at least one filename using data received in response to the simplified data request command, the image for each image file being either one of a reduced image for the corresponding image file and a prescribed icon indicating the corresponding image file.

According to another aspect, the invention provides a storage medium storing a set of program instructions executable on an image processor, the instructions including: acquiring filename for an image file stored on a removable medium; and attaching a prescribed specification command to the acquired filename and outputting the filename.

### BRIEF DESCRIPTION OF THE DRAWINGS

In the drawings;

FIG. 1(a) is a sample screenshot on the display screen of a personal computer showing image files read from a conventional USB removable media device and displayed as thumbnail images;

FIG. 1(b) is a sample screenshot on the display screen of a personal computer showing image files read from a conventional FTP removable media device;

FIG. 2 is a block diagram showing the structure of an image displaying system according to an embodiment of the present invention;

FIG. 3 is an explanatory diagram illustrating a display screen for thumbnail images displayed on the display panel of a personal computer when a reduced display mode has been set;

FIG. 4 is an explanatory diagram conceptually illustrating the structure of an image file in the JPEG format stored on a memory card;

FIG. 5 is an explanatory diagram illustrating a display screen for thumbnail images displayed on the display panel of a personal computer when a simplified display mode has been set;

FIG. 6(a) and FIG. 6(b) are explanatory diagrams conceptually illustrating processes executed on a multifunction peripheral and the personal computer, wherein FIG. 6(a) illustrates the process performed when the reduced display mode has been set, and FIG. 6(b) illustrates the process performed when the simplified display mode has been set;

FIG. 7 is a flowchart illustrating steps in a process performed on the personal computer to display thumbnail images;

FIG. 8 is a flowchart illustrating steps in a process executed on the personal computer to perform a direct printing operation;

FIG. 9 is a flowchart illustrating steps in a process executed on the multifunction peripheral for outputting thumbnail image data; and

FIG. 10 is a flowchart illustrating steps in a process executed on the multifunction peripheral to perform a direct printing operation.

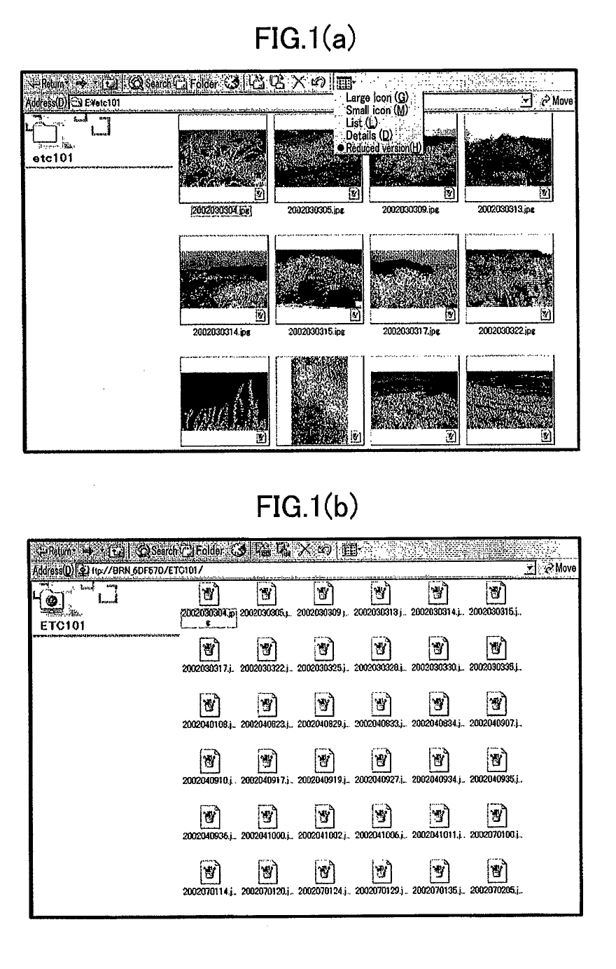

### DETAILED DESCRIPTION

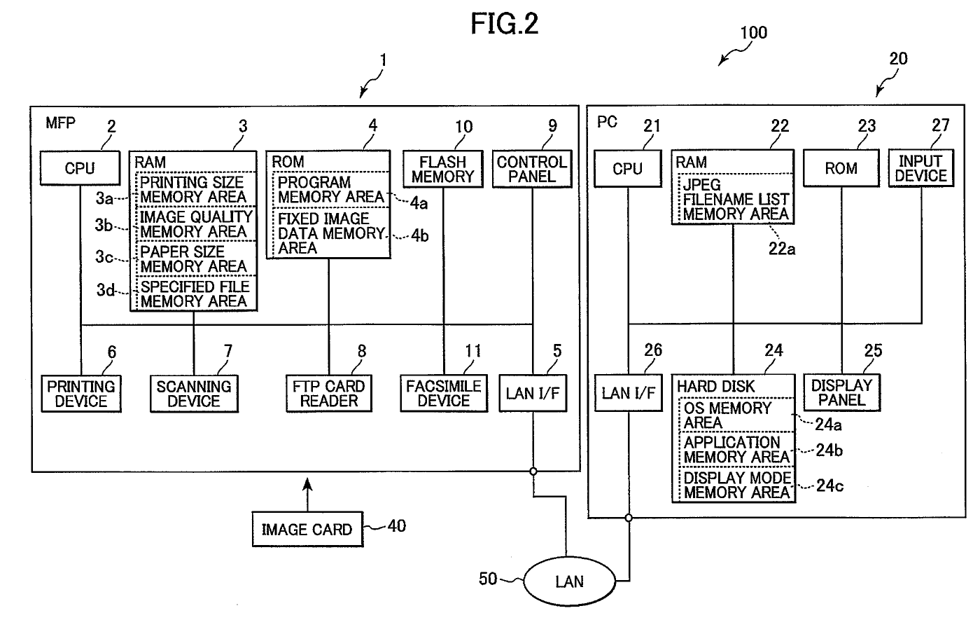

Next, an embodiment of the present invention will be described while referring to the accompanying drawings. FIG. 2 is a block diagram showing an image displaying system 100 according to the embodiment. As shown in FIG. 2, the image displaying system 100 is configured of a multifunction peripheral 1 that functions as a removable media device, and a personal computer 20 connected to the multifunction peripheral 1 via a local area network (LAN) 50 that functions as an image processor.

The multifunction peripheral 1 includes various functions in one unit, including a photomedia capture function, a printer function, a copier function, a scanner function, and a facsimile function. As shown in FIG. 2, the multifunction peripheral 1 includes primarily: a CPU 2 that controls the overall operations of the multifunction peripheral 1; a RAM 3, which is a memory functioning to temporarily store data and the like required in various processes executed by the CPU 2; a ROM 4 for storing various control programs executed by the CPU 2 and fixed value data; a LAN interface 5; a printing device 6; a scanning device 7; an FTP card reader 8; a control panel 9 configured of a plurality of input keys (buttons and switches) that allow the users to implement various functions on the multifunction peripheral 1, and a display screen; a flash memory 10; and a facsimile device 11 for transmitting and receiving image data through a telephone line (not shown).

The CPU 2 is a processor that executes various programs stored in the ROM 4. The RAM 3 is a random access memory that includes a work area for temporarily storing variables and the like when the CPU 2 executes programs. The RAM 3 includes a printing size memory area 3a, an image quality memory area 3b, a paper size memory area 3c, and a specified file memory area 3d.

The printing size memory area 3a functions to store a user-specified printing size. This printing size is a value indicating how many pages to print on a single sheet of recording paper and how the pages are arranged horizontally and vertically on the sheet of recording paper. For example, when printing one page worth on a single sheet of recording paper, a value indicating 1×1 (horizontal×vertical) is stored in the printing size memory area 3a. When printing four pages worth on a single sheet of recording paper arranged two pages horizontally by two pages vertically, a value indicating 2×2 (horizontal×vertical) is stored in the printing size memory area 3a.

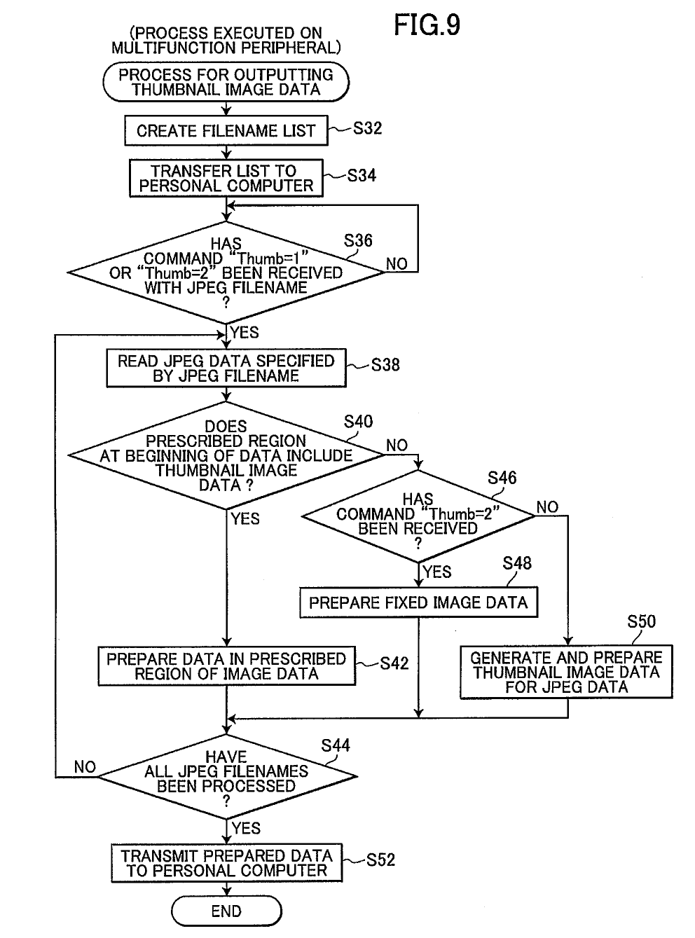

The image quality memory area 3b stores a user-specified image quality. For example, if the user sets the image quality to fine F (normal image quality), a value indicating fine F is stored in the image quality memory area 3b. If the user sets the image quality to superfine sF, then a value indicating superfine sF is stored in the image quality memory area 3b. The paper size memory area 3c stores the size of the recording paper used for printing by the printing device 6. In the process of FIG. 9 described later for executing a direct printing operation, upon receiving settings for a direct print from the personal computer 20, the multifunction peripheral 1 writes the printing size, image quality, and paper size described in the direct print settings to the printing size memory area 3a, image quality memory area 3b, and paper size memory area 3c, respectively.

The specified file memory area 3d stores an image file to be printed by the printing device 6. In the process of FIG. 9 described later for executing a direct printing operation, when a specification command has been attached to the filename received from the personal computer 20, the multifunction peripheral 1 reads an image file corresponding to the filename from an image card 40 (removable medium) and writes the image file to the specified file memory area 3d. The printing device 6 subsequently prints the image file written to the specified file memory area 3d. The specification command will be described below in greater detail.

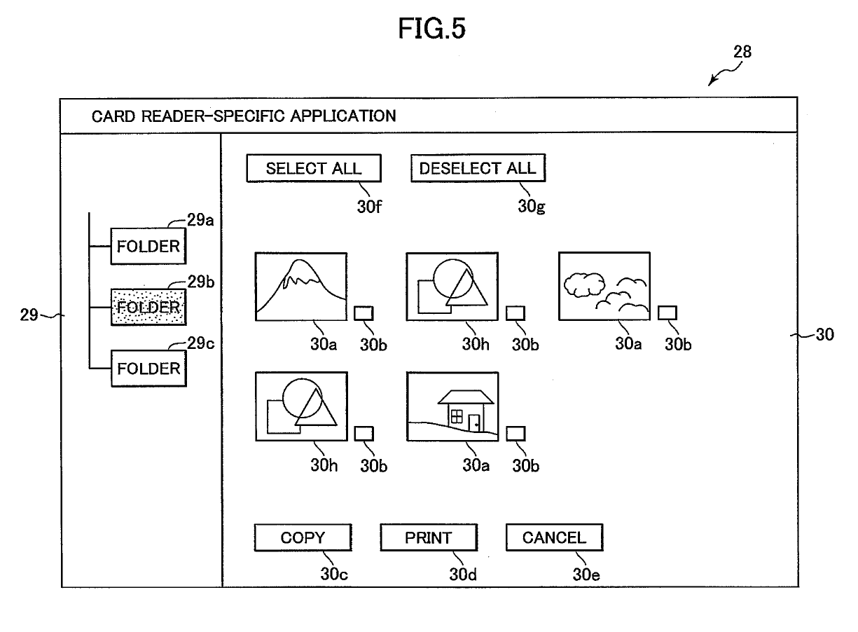

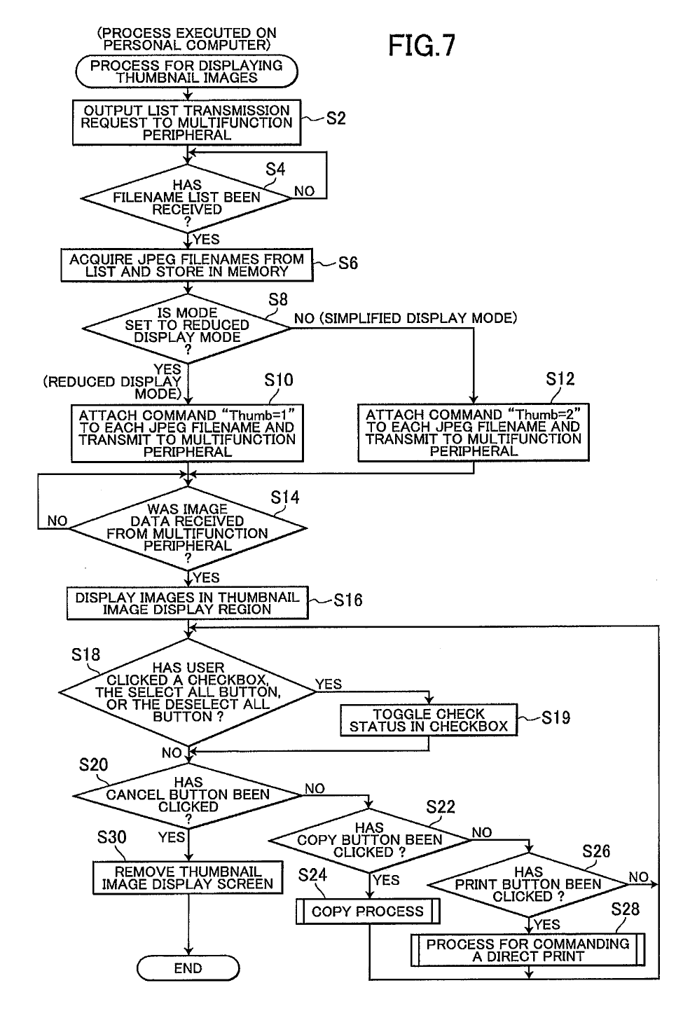

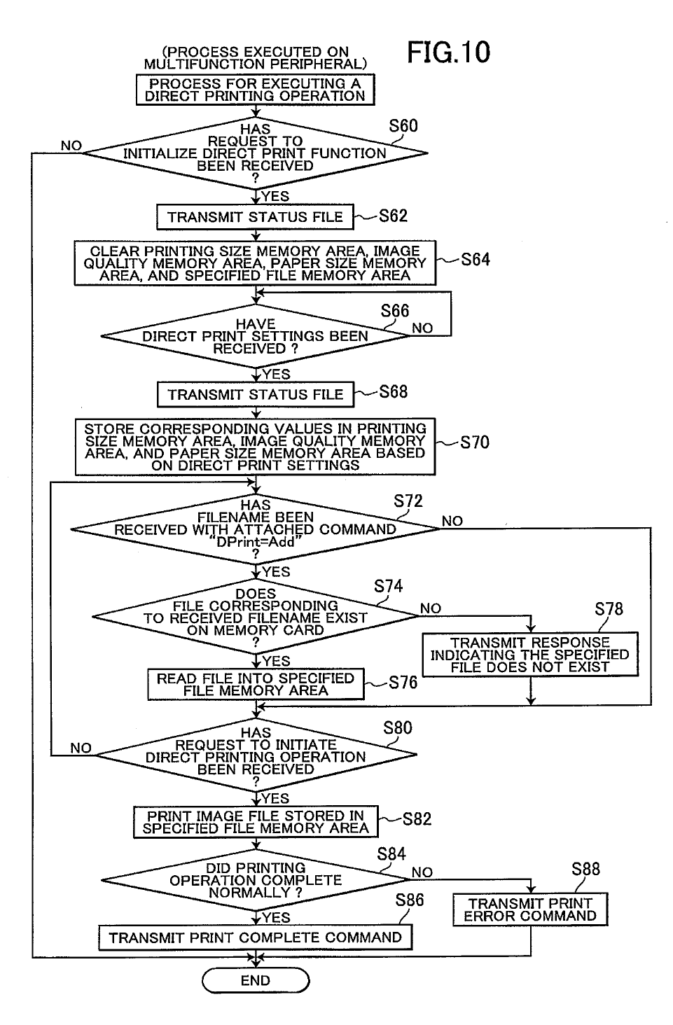

The ROM 4 includes a program memory area 4a storing various programs, including a program for executing the process shown in the flowcharts of FIG. 9 and FIG. 10, and a fixed image data memory area 4b. The CPU 2 reads fixed image data or icon data stored in the fixed image data memory area 4b during a process in FIG. 7 described later for outputting thumbnail image data and transmits this fixed image data to the personal computer 20. Upon receiving the fixed image data, the personal computer 20 displays a predetermined fixed image 30h (see FIG. 5) indicating an image file on the image card 40 on a display panel 25 according to the fixed image data. The fixed image 30h is a predetermined icon indicative of a predetermined figure, symbol, or the like.

The control panel 9 includes the plurality of operating keys and the display screen. The user can input instructions in the multifunction peripheral 1 by manipulating the keys. The operating keys include mode selection keys for selecting such functions as the photomedia capture function, copier function, scanner function, and facsimile function; and a ten-key pad for inputting alphanumeric characters. By operating the mode selection keys, the user can set the multifunction peripheral 1 to a photomedia capture mode implementing the photomedia capture function, a copier mode implementing the copier function, a scanner mode implementing the scanner function, or a facsimile mode implementing the facsimile function.

By manipulating the keys in the ten-key pad, the user can input a facsimile number to which a facsimile is to be transmitted, or a number of copies when performing a copy operation. The display screen displays an options screen indicating user settings and the like, for example.

The flash memory 10 is a nonvolatile memory capable of storing various data that can be written thereto and read therefrom. The flash memory 10 stores a network address (IP address) or a node name for the multifunction peripheral 1 on the LAN 50.

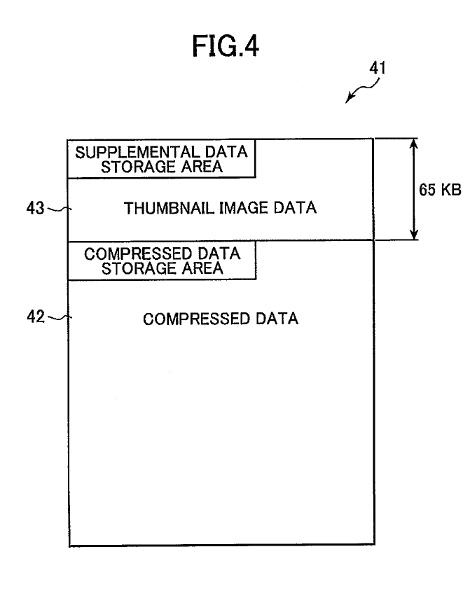

The LAN interface 5 facilitates communications via the LAN 50. In the embodiment, the protocol for file transfers used by the LAN 50 is the file transfer protocol (FTP). When the multifunction peripheral 1 is set in the photomedia capture mode and the image card 40 is inserted in the FTP card reader 8, image files 41 (FIG. 4) stored on the image card 40 can be outputted to the personal computer 20 connected to the LAN 50 via the LAN interface 5.

The printing device 6 is an inkjet printer for printing images on a recording paper set at a prescribed feeding position (not shown) based on instructions from the CPU 2. The printing device 6 includes a paper-conveying motor (not shown) for conveying the recording paper, a print head (not shown) for ejecting ink onto the recording paper, and a carriage motor (not shown) for moving a carriage (not shown) on which the print head is supported. When the multifunction peripheral 1 is set in the photomedia capture mode and the image card 40 is inserted into the FTP card reader 8, the printing device 6 can directly print the image files 41 (see FIG. 4) stored on the image card 40.

The scanning device 7 reads an image from an original set at a prescribed scanning position (not shown) based on instructions from the CPU 2. When the multifunction peripheral 1 is set in the copier mode, the printing device 6 prints image data generated by the scanning device 7 on recording paper. If the multifunction peripheral 1 is set in the scanner mode, image data generated by the scanning device 7 is stored in a prescribed storage area of the RAM 3 and subsequently transferred to the personal computer 20 or the like via the LAN 50.

The FTP card reader 8 includes a plurality of slots in which various types of image cards 40 can be detachably inserted. The FTP card reader 8 can read data stored on the image card 40 mounted in one of the slots and can write desired data to the same. When the multifunction peripheral 1 is set in the photomedia capture mode, the CPU 2 can read data from the image card 40 mounted in the FTP card reader 8 and direct the printing device 6 to print this data or output the data to the personal computer 20 via the LAN 50. The image card 40 is configured of flash memory that is rewritable and can preserve data when the power to the multifunction peripheral 1 is cut off. The image card 40 may be one of various types provided from different companies, such as the SD Card and the xD Card.

The image card 40 includes a data memory area storing the image files 41 (see FIG. 4) taken by a digital camera or the like and text data or other data created on a computer, for example. The multifunction device 1 employs the FAT (File Allocation Table) as a file system for managing the image files 41 in the image card 40.

The facsimile device 11 functions to transmit image data read by the scanning device 7 or other data received via the LAN 50 to another facsimile device via a telephone line. Data received by the facsimile device 11 through the telephone line can be printed on the printing device 6 or transmitted to the personal computer 20 via the LAN 50.

Next, the structure of the personal computer 20 will be described. The personal computer 20 includes: a CPU 21; a RAM 22, a memory that functions to temporarily store data, programs, and the like required in various processes executed by the CPU 21; a ROM 23 for storing various control programs executed by the CPU 21 and fixed value data; a hard disk 24, which is a nonvolatile rewritable memory device for storing various settings; an input device 27 configured of a keyboard and mouse having a plurality of input keys for setting various functions; the display panel 25 configured of a liquid crystal display and functioning to display various data; and a LAN interface 26 for establishing a connection with the LAN 50.

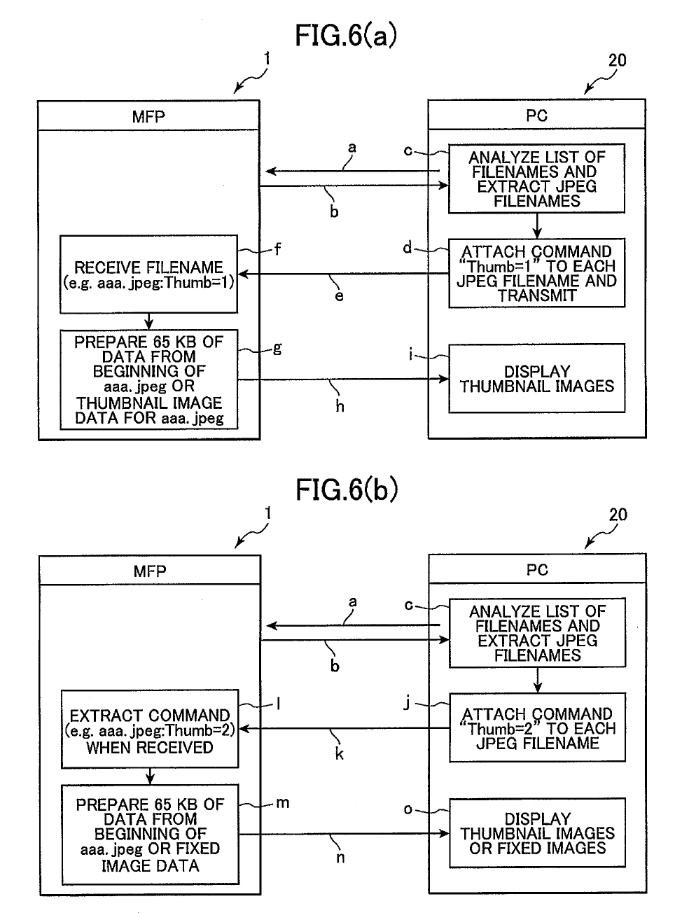

The RAM 22 includes a JPEG (Joint Photographic Experts Group) filename list memory area 22a. The JPEG filename list memory area 22a stores JPEG filenames acquired in a process for displaying thumbnail images described later with reference to FIG. 6. The JPEG filenames will also be described later.

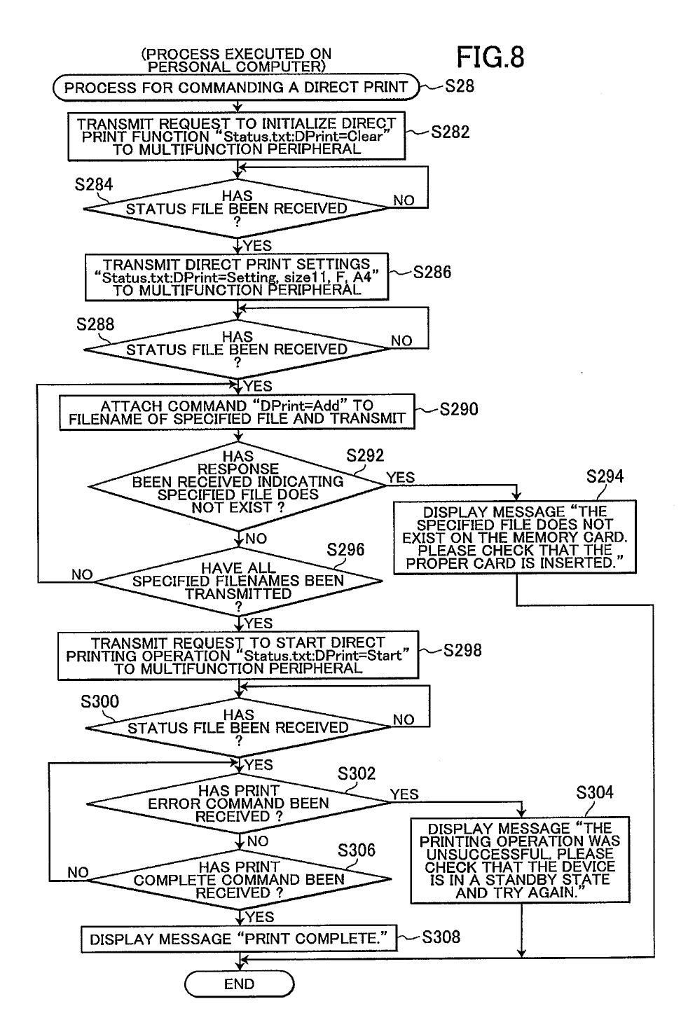

The hard disk 24 includes an OS memory area 24a for storing an operating system (OS), an application memory area 24b for storing various application programs (hereinafter abbreviated as “applications”), and a display mode memory area 24c. In the embodiment, the application memory area 24b stores a card reader-specific application for implementing the process shown in the flowcharts of FIG. 7 and FIG. 8. The card reader-specific application displays a plurality of images corresponding to the plurality of image files 41 in the image card 40 in a single screen on the display panel 25 at a reduced size, and prompts the user to execute a process for printing image files 41 in the image card 40 on the multifunction peripheral 1.

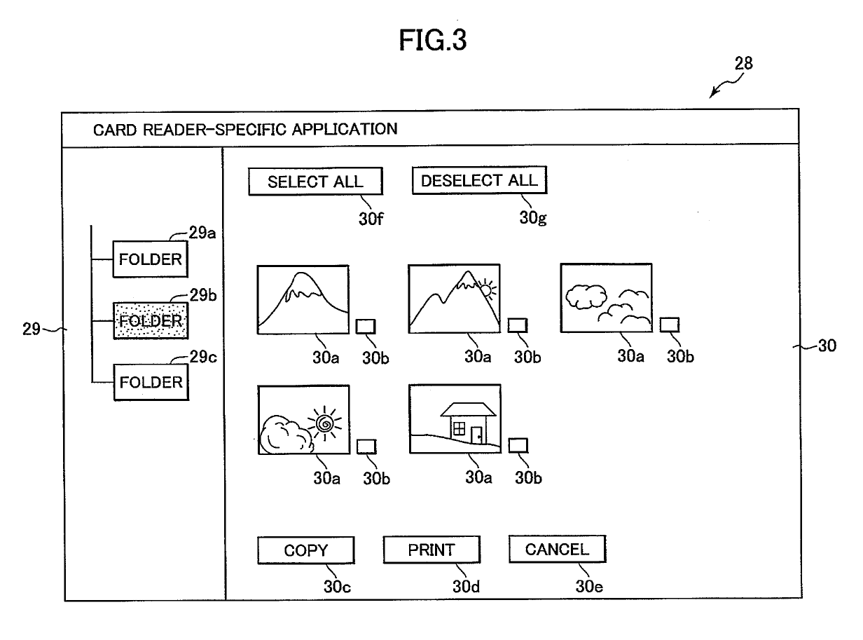

The display mode memory area 24c stores the display mode that is currently set. The display mode for the display on the display panel 25 can be set to either a reduced display mode or a simplified display mode. In the reduced display mode, the personal computer 20 displays all image files 41 of the JPEG format stored on the image card 40 at a reduced size in one screen. In the simplified display mode, the personal computer 20 displays a thumbnail image 30a (see FIG. 3) based on thumbnail image data when the thumbnail image data is included in the image file 41 for all image files 41 of the JPEG format stored on the image card 40, and displays an existing fixed image or icon 30h (see FIG. 5) for image files 41 that do not include thumbnail image data. The user performs a prescribed input operation on the input device 27 to set a desired display mode, which is stored in the display mode memory area 24c.

Next, an overview of the processes performed on the multifunction peripheral 1 and personal computer 20 will be described with reference to FIG. 3 through FIG. 6(b).

FIG. 3 shows an example of a thumbnail image display screen 28 displayed on the display panel 25 of the personal computer 20 in the reduced display mode. As shown in FIG. 3, the thumbnail image display screen 28 is configured of a directory tree display region 29 displayed in the left side of the display panel 25, and a thumbnail image display region 30 displayed to the right of the directory tree display region 29. The directory tree display region 29 displays folder icons 29a symbolizing the plurality of folders stored on the image card 40 in a tree structure. The thumbnail image display region 30 displays thumbnail images 30a of the image files 41 stored on the image card 40. The thumbnail image display screen 28 is displayed when the card reader-specific application stored in the application memory area 24b is started. Specifically, when the user starts the card reader-specific application on the personal computer 20, the personal computer 20 transmits a prescribed command to the multifunction peripheral 1 for setting the multifunction peripheral 1 in the photomedia capture mode.

When the thumbnail image display screen 28 is initially displayed upon launching the card reader-specific application, only the folder icons 29a in the directory tree display region 29 are displayed, while the thumbnail image display region 30 remains blank. The tree structure display in the directory tree display region 29 allows the user to visually perceive the hierarchical structure of folders stored on the image card 40.

If the user clicks on one of the folder icons 29a displayed in the directory tree display region 29, all of the image files 41 in the folder corresponding to the selected folder icon 29a are displayed in reduced form in the thumbnail image display region 30. Each of the images reduced in size and displayed in the thumbnail image display region 30 for the image files 41 is represented by a thumbnail image 30a. By looking over the plurality of thumbnail images 30a displayed in the thumbnail image display region 30, the user can quickly and easily determine which of the image files 41 are stored in the selected folder.

As shown in FIG. 3, a checkbox 30b is displayed next to each of the thumbnail images 30a in the thumbnail image display region 30 for selecting the corresponding thumbnail image 30a. The user selects a thumbnail image 30a by inserting a check in the checkbox 30b provided next to the desired thumbnail image 30a with a mouse click, for example. If the user subsequently clicks on a Copy button 30c displayed in the bottom of the thumbnail image display region 30 while a check is inserted in one of the checkboxes 30b, the image file 41 corresponding to the thumbnail image 30a next to the checked checkbox 30b is outputted from the multifunction peripheral 1 and stored in a prescribed location on the personal computer 20.

However, if the user clicks a Print button 30d displayed to the right of the Copy button 30c while a check is inserted in one of the checkboxes 30b, then the image file 41 corresponding to the selected thumbnail image 30a is printed with the printing device 6 of the multifunction peripheral 1. While not shown in the drawings, a Print Settings dialog window is displayed when the user clicks in a prescribed position of the thumbnail image display screen 28. The user can input a desired printing size, image quality, and paper size in the Print Settings dialog window to modify the print settings.

If the user clicks on a Cancel button 30e displayed to the right of the Print button 30d, then the thumbnail image display screen 28 is removed from the display.

In addition, a Select All button 30f and a Deselect All button 30g are displayed at the top of the thumbnail image display region 30. If the user clicks on the Select All button 30f, a check is inserted in all checkboxes 30b displayed in the thumbnail image display region 30. However, if the user selects the Deselect All button 30g, checks are removed from all checkboxes 30b displayed in the thumbnail image display region 30. Hence, the user can select or deselect all thumbnail images 30a through a simple operation.

It is necessary to acquire thumbnail image data to display the thumbnail images 30a on the personal computer 20. In this example, thumbnail image data is pre-stored at the beginning of each JPEG image file 41 taken by the digital camera. Hence, in the image displaying system 100 according to the embodiment, this thumbnail image data stored in the image files 41 is read and used to display the thumbnail images 30a on the personal computer 20.

FIG. 4 is a conceptual image of an image file 41 stored on the image card 40. As shown in FIG. 4, the image file 41 is configured of a compressed data storage area 42 storing compressed data corresponding to a static image, and a supplemental data storage area 43 preceding the compressed data storage area 42 and storing supplemental data on the compressed data. When thumbnail image data (reduced data indicative of a reduced image for the static image indicated by the compressed data in the compressed data storage area 42) is included in the image file 41, the thumbnail image data is stored within the supplemental data storage area 43 at a region that includes a maximum of 65 KB from the beginning of the image file 41. Therefore, in order to output the thumbnail image data to the personal computer 20 when the image file 41 includes such data, data stored in the 65-KB region at the head of the image file 41 that includes the thumbnail image data is outputted to the personal computer 20.

However, some of the image files 41 may not include thumbnail image data. In these cases, the multifunction peripheral 1 must generate thumbnail image data and transmit this data to the personal computer 20 for image files 41 that do not include thumbnail image data so that the personal computer 20 can display thumbnail images 30a for all image files 41 in the specified folder when the reduced display mode is set in the display mode memory area 24c (see FIG. 2). In this way, the personal computer 20 can display thumbnail images 30a for all image files 41 in the thumbnail image display screen 28 when the reduced display mode is set (see FIG. 3).

Next, an example of displaying the thumbnail image display screen 28 when the simplified display mode has been set will be described with reference to FIG. 5. FIG. 5 shows an example of the thumbnail image display screen 28 displayed on the display panel 25 of the personal computer 20 when the simplified display mode has been set. The thumbnail image display screen 28 shown in FIG. 5 has the same structure as the thumbnail image display screen 28 described with reference to FIG. 3 and, hence, like parts and components are designated with the same reference numerals to avoid duplicating description.

As described above, when the reduced display mode has been set, the multifunction peripheral 1 generates and transmits thumbnail image data for image files 41 that do not already include thumbnail image data so that the personal computer 20 can display thumbnail images 30a for all image files 41. In the simplified display mode, the multifunction peripheral 1 transmits fixed image data or icon data stored in the fixed image data memory area 4b for image files 41 that do not include thumbnail image data, and the personal computer 20 displays the fixed images or icons 30h on the thumbnail image display screen 28 in place of the thumbnail images 30a for these image files 41.

Next, the overall process of displaying the thumbnail images 30a on the thumbnail image display region 30 will be described with reference to FIG. 6(a) and FIG. 6(b). FIG. 6(a) and FIG. 6(b) conceptually illustrate an outline of the processes executed on the multifunction peripheral 1 and the personal computer 20, wherein FIG. 6(a) illustrates the process performed when the reduced display mode has been set, and FIG. 6(b) illustrates the process performed when the simplified display mode has been set.

First, the process performed when the reduced display mode has been set will be described with reference to FIG. 6(a). When the user clicks on a folder icon 29a in the tree structure (see FIG. 3) displayed on the personal computer 20, the personal computer 20 outputs a list transmission request to the multifunction peripheral 1 requesting a list of filenames for all files stored in the folder on the image card 40 represented by the selected folder icon 29a [a].

Upon receiving the list transmission request, the multifunction peripheral 1 creates a list of filenames for the corresponding folder in the image card 40 and transmits this list to the personal computer 20 that issued the request [b]. The list of filenames transmitted to the personal computer 20 includes filenames of all files stored in the specified folder, regardless of whether the files are of the JPEG format.

Upon receiving the list of filenames from the multifunction peripheral 1, the personal computer 20 analyzes the list to extract filenames for image files 41 of the JPEG format (hereinafter referred to as “JPEG filenames”) [c]. The personal computer 20 attaches a reduced display command “Thumb=1” to each of the extracted JPEG filenames [d]. At this time, the symbol “:” is added between the reduced display command “Thumb=1” and the JPEG filename as a separator. For example, when the reduced display command is attached to the JPEG filename “aaa.jpeg,” the result is “aaa.jpeg:Thumb=1.” The function of the separator will be described later in greater detail.

The personal computer 20 transmits the JPEG filenames with the reduced display command “Thumb=1” attached to each to the multifunction peripheral 1 [e]. Upon receiving the JPEG filenames with attached reduced display command “Thumb=1” [f], the multifunction peripheral 1 separates the JPEG filename and reduced display command “Thumb=1,” with the separator “:” functioning as a carriage return (linefeed). Here, the symbol “:” used as the separator can be used as a character in a filename according to the FTP protocol, but is not recognized as part of the filename in the file system used on the multifunction peripheral 1 (FAT in the embodiment). Hence, the JPEG filename with attached reduced display command (such as “aaa.jpeg:Thumb=1”) passes as an integrated filename in FTP protocol when transmitted to the multifunction peripheral 1, but functions as a separator in the multifunction peripheral 1.

Based on the reduced display command “Thumb=1” separated from the JPEG filename according to the separator “:”, the multifunction peripheral 1 determines whether the image file 41 corresponding to the received JPEG filename (such as “aaa.jpeg”) includes thumbnail image data. The multifunction peripheral 1 prepares the data stored in the 65-KB region at the beginning of the image file 41 when the image file 41 includes thumbnail image data. However, the multifunction peripheral 1 generates and prepares thumbnail image data for image files 41 that do not include thumbnail image data [g].

The multifunction peripheral 1 transmits the prepared data to the personal computer 20 [h]. The personal computer 20 can use the thumbnail image data received from the multifunction peripheral 1 to display the thumbnail images 30a in the thumbnail image display region 30 [i].

Next, the process performed when the simplified display mode has been set will be described with reference to FIG. 6(b). Since some of the steps in the process of FIG. 6(b) are identical to those in FIG. 6(a), the steps have been designated with the same reference letters.

As shown in FIG. 6(b), when the simplified display mode has been set, the personal computer 20 attaches a simplified display command “Thumb=2” to each of the acquired JPEG filenames [j]. At this time, the personal computer 20 adds the symbol “:” between the simplified display command “Thumb=2” and the JPEG filename as a separator.

Next, the personal computer 20 transmits JPEG filenames with the attached simplified display command “Thumb=2” to the multifunction peripheral 1 [k]. Upon receiving the JPEG filenames with attached simplified display command “Thumb=2” [l], the multifunction peripheral 1 separates the JPEG filename from the simplified display command “Thumb=2”, with the separator “:” functioning as a carriage return (linefeed).

Based on the simplified display command “Thumb=2” separated from the JPEG filename by the separator “:”, the multifunction peripheral 1 determines whether the image file 41 corresponding to the received JPEG filename (such as “aaa.jpeg”) includes thumbnail image data. For image files 41 that include thumbnail image data, the multifunction peripheral 1 prepares the data stored in the 65-KB region at the beginning of the image file 41. For image files 41 that do not include thumbnail image data, the multifunction peripheral 1 reads fixed image data from the fixed image data memory area 4b (see FIG. 2) and prepares this data [m].

The multifunction peripheral 1 transmits the prepared data to the personal computer 20 [n]. The personal computer 20 can use the received thumbnail image data or fixed image data to display the thumbnail images 30a or fixed images 30h in the thumbnail image display region 30 [o].

FIG. 7 is a flowchart illustrating steps in a thumbnail image displaying process performed on the personal computer 20. The process for displaying thumbnail images begins when the user clicks on one of the folder icons 29a displayed on the personal computer 20 in the directory tree display region 29.

In S2 of the process in FIG. 7, the CPU 21 of the personal computer 20 requests a list of filenames by outputting a list transmission request to the multifunction peripheral 1. In S4 the CPU 21 waits to receive a list of filenames from the multifunction peripheral 1 in response to the list transmission request. If a list of filenames is received from the multifunction peripheral 1 (S4: YES), then in S6 the CPU 21 extracts JPEG filenames from the received list of filenames and stores the JPEG filenames in the JPEG filename list memory area 22a. The CPU 21 repeats the process in S4 as long as a list of filenames has not been received from the multifunction peripheral 1 (S4: NO).

In S8 the CPU 21 determines whether the display mode is set to the reduced display mode by referencing the display mode memory area 24c (see FIG. 2). If the reduced display mode has been set (S8: YES), then in S10 the CPU 21 adds the reduced display command “Thumb=1” and the separator “:” to separate the command from the JPEG filename to each JPEG filename stored in the JPEG filename list memory area 22a and transmits the results to the multifunction peripheral 1. However, if the display mode set in the display mode memory area 24c is the simplified display mode (S8: NO), then in S12 the CPU 21 adds the simplified display command “Thumb=2” and the separator “:” for separating the command from the JPEG filename to each JPEG filename stored in the JPEG filename list memory area 22a and transmits the results to the multifunction peripheral 1. Hence, the determination in S8 serves to select whether the reduced display command “Thumb=1” or the simplified display command “Thumb=2” is attached as a command to the JPEG filenames based on the user's setting.

In S14 the CPU 21 waits until data has been received from the multifunction peripheral 1 in response to the reduced display command “Thumb=1” or the simplified display command “Thumb=2”. When data has been transmitted from the multifunction peripheral 1 in response to the command (S14: YES), then in S16 the CPU 21 displays either the thumbnail image 30a or the fixed image 30h in the thumbnail image display region 30 using the received data. The CPU 21 repeats the process in S14 as long as data has not been received from the multifunction peripheral 1 (S14: NO). As described above with reference to FIG. 3, when the display mode set in the display mode memory area 24c is the reduced display mode, the CPU 21 can receive thumbnail image data for image files 41 corresponding to JPEG filenames transmitted in the process of S10. Therefore, thumbnail images 30a are displayed in the thumbnail image display region 30 for all image files 41. However, when the display mode is set to the simplified display mode, as described with reference to FIG. 5, the CPU 21 receives fixed image data for image files 41 that do not include thumbnail image data from among the image files 41 corresponding to JPEG filenames that were transmitted in the process of S12. Therefore, the fixed image 30h is displayed for image files 41 that do not include thumbnail image data.

In S18 the CPU 21 determines whether the user has clicked on one of the checkboxes 30b, Select All button 30f, or Deselect All button 30g in the thumbnail image display region 30 in which the thumbnail images 30a and/or fixed images 30h are displayed (see FIG. 3 or FIG. 5). If one of the checkboxes 30b, Select All button 30f, and Deselect All button 30g has been clicked (S18: YES), in S19 the CPU 21 changes the existence of a check in checkboxes corresponding to the clicked position. For example, if a checkbox 30b has been clicked, the CPU 21 removes the check from the checkbox 30b if a check exists or places a check in the checkbox 30b if a check does not exist. Further, if the Select All button 30f was clicked, the CPU 21 places a check in all of the checkboxes 30b. If the Deselect All button 30g was clicked, then the CPU 21 removes checks from all of the checkboxes 30b.

However, if none of the checkboxes 30b, Select All button 30f, and Deselect All button 30g was clicked (S18: NO), then the CPU 21 skips the process in S19 and advances directly to S20.

In S20 the CPU 21 determines whether the Cancel button 30e has been clicked in the thumbnail image display region 30 (see FIG. 3 or FIG. 5). If the Cancel button 30e has not been clicked (S20: NO), then in S22 the CPU 21 determines whether the Copy button 30c has been clicked. If the Copy button 30c has been clicked (S22: YES), then in S24 the CPU 21 executes a copy process for outputting a prescribed command to the multifunction peripheral 1, receiving the image files 41 corresponding to thumbnail images 30a next to checkboxes 30b that have been checked from the multifunction peripheral 1, and storing the image files 41 on the hard disk 24 (see FIG. 2).

However, if the Copy button 30c was not clicked (S22: NO), then in S26 the CPU 21 determines whether the Print button 30d was clicked. If the Print button 30d was clicked (S26: YES), then in S28 the CPU 21 executes a process for commanding a direct print described later. If the Print button 30d was not clicked (S26: NO), then the CPU 21 returns to S18 and repeats the process until the Cancel button 30e has been clicked. When the Cancel button 30e has been clicked (S20: YES), then in S30 the CPU 21 removes the thumbnail image display screen 28 from the display panel 25 and ends the process.

By exchanging commands, thumbnail image data, or fixed image data between the multifunction peripheral 1 and the personal computer 20 according to the thumbnail image displaying process described above, the personal computer 20 can display thumbnail images 30a or fixed images 30h on the thumbnail image display region 30. Hence, this process can achieve data communications in a shorter amount of time than can a process for reading the image files in their entirety from the multifunction peripheral 1, allowing the user to view the image files 41 in the image card 40 quickly and easily so that the user can select an appropriate image file 41 to be copied or printed. Further, if the simplified display mode has been set, then the multifunction peripheral 1 need not generate thumbnail image data. Accordingly, the thumbnail images 30a or fixed images 30h can be displayed in the thumbnail image display region 30 in a shorter amount of time.

Next, the process executed on the personal computer 20 in S28 for commanding a direct print will be described with reference to FIG. 8. FIG. 8 is a flowchart illustrating steps in this process. The process in S28 for commanding a direct print instructs the multifunction peripheral 1 to print on the printing device 6 image files 41 that are indicated by a check inserted into the checkboxes 30b in the thumbnail image display screen 28.

In S282 at the beginning of the process, the CPU 21 transmits a request to initialize the direct print function to the multifunction peripheral 1. The direct print function initialization request is configured of data required for clearing the printing size memory area 3a, image quality memory area 3b, paper size memory area 3c, and specified file memory area 3d on the multifunction peripheral 1. In the embodiment, the direct print function initialization request is “Status.txt:DPrint=Clear.” The direct print function initialization request transmitted from the personal computer 20 passes through FTP protocol as an integrated filename and allows the multifunction peripheral 1 receiving the request to separate the filename “Status.txt” from the initialization command “DPrint=Clear” according to the separator “:”. Upon receiving the request, the multifunction peripheral 1 outputs a file having the filename “Status.txt” (hereinafter referred to as the “status file”) stored on the ROM 4 based on the received filename “Status.txt,” and clears the printing size memory area 3a, image quality memory area 3b, paper size memory area 3c, and specified file memory area 3d based on the initialization command “DPrint=Clear.”

In S284 the CPU 21 of the personal computer 20 waits until the status file is received from the multifunction peripheral 1. If the direct print function initialization request transmitted in S282 is received normally by the multifunction peripheral 1, then the multifunction peripheral 1 will return the status file, as described above. Accordingly, the CPU 21 can determine that the direct print function initialization request was transmitted properly based on whether the status file was received from the multifunction peripheral 1.

Upon receiving the status file from the multifunction peripheral 1 (S284: YES), in S286 the CPU 21 transmits direct print settings to the multifunction peripheral 1. The direct print settings includes data describing user-specified print settings. In the embodiment, the direct print settings are configured of “Status.txt:DPrint=Setting, . . . ” followed by data describing the user-specified printing size, image quality, and paper size.

As with the direct print function initialization request described above, the multifunction peripheral 1 separates the direct print settings into the filename “Status.txt” and the settings command “DPrint=Setting, . . . ” including a description of the print settings according to the separator “:”. Subsequently, the multifunction peripheral 1 outputs the status file to the personal computer 20 based on the received filename “Status.txt,” and stores the printing size, image quality, and paper size described in the settings command in the printing size memory area 3a, image quality memory area 3b, and paper size memory area 3c, based on the settings command “DPrint=Setting, . . . .”

For example, when the direct print settings is “Status.txt:DPrint=Setting, size11, F, A4,” the multifunction peripheral 1 separates the settings command “DPrint=Setting, size11, F, A4” from the filename based on the separator “:”. Based on this data, the multifunction peripheral 1 stores a value in the printing size memory area 3a indicating 1×1 (horizontal×vertical) for printing one page worth on one sheet of recording paper based on “size11.” Next, the multifunction peripheral 1 stores a value indicating the fine F image quality in the image quality memory area 3b based on “F”. Next, the multifunction peripheral 1 stores a value in the paper size memory area 3c indicating the A4 size of recording paper used for printing on the printing device 6 based on “A4”.

In S288 the CPU 21 waits until a status file is received from the multifunction peripheral 1. When a status file is received from the multifunction peripheral 1 (S288: YES), then in S290 the CPU 21 reads JPEG filenames of the specified image files 41 from the JPEG filename list memory area 22a based on checks inputted in the checkboxes 30b in the thumbnail image display screen 28, adds the separator “:” and the specification command “DPrint=Add” to the JPEG filenames, and transmits the results to the multifunction peripheral 1.

As with the direct print function initialization request described above, the multifunction peripheral 1 separates the specification command “DPrint=Add” from the JPEG filename based on the separator “:”. Next, the multifunction peripheral 1 reads the image file 41 having the received JPEG filename from the image card 40 and stores the image file 41 in the specified file memory area 3d. If a image file 41 corresponding to the received JPEG filename does not exist in the image card 40, then the multifunction peripheral 1 transmits a response to the personal computer 20 indicating that the user-specified image file 41 does not exist on the image card 40.

Consequently, in S292 the CPU 21 receives a response indicating that the specified file does not exist (S292: YES) and in S294 displays a message on the display panel 25, such as “The specified file does not exist on the memory card. Please check that the proper card is inserted.” Through this notification, the user can take the appropriate steps, such as checking the inserted state of the image card 40 in the multifunction peripheral 1.

However, if a response indicating that the specified file does not exist is not received (S292: NO), then in S296 the CPU 21 determines whether all specified JPEG filenames have been transmitted. If not all specified filenames have been transmitted (S296: NO), then the CPU 21 repeats the process from S290. However, when the CPU 21 has added the specification command “DPrint=Add” to all specified JPEG filenames and has transmitted all filenames to the multifunction peripheral 1 (S296: YES), then in S298 the CPU 21 transmits a request to begin a direct printing operation to the multifunction peripheral 1.

The request to begin a direct printing operation is configured of data required to initiate a printing operation on the multifunction peripheral 1. In the embodiment, this request is configured of “Status.txt:DPrint=Start.” The multifunction peripheral 1 separates the request to begin a direct printing operation received from the personal computer 20 into the filename “Status.txt” and a start command “DPrint=Start” according to the separator “:”. The multifunction peripheral 1 outputs the status file to the personal computer 20 based on the received filename “Status.txt” and begins printing the image files 41 stored in the specified file memory area 3d.

In S300 the CPU 21 waits until a status file has been received from the multifunction peripheral 1. The CPU 21 can determine that the request to begin a direct printing operation was properly received in the multifunction peripheral 1 based on whether the status file is received. If a status file is received from the multifunction peripheral 1 (S300: YES), in S302 the CPU 21 determines whether a print error command has been received from the multifunction peripheral 1. The print error command is a command outputted by the multifunction peripheral 1 to the personal computer 20 when a print error of some kind has occurred, and will be described later in greater detail.

If a print error command has been received from the multifunction peripheral 1 (S302: YES), then in S304 the CPU 21 displays a message on the display panel 25, such as “The printing operation was unsuccessful. Please check that the device is in a standby state and try again.” Through this notification, the user can take the appropriate steps, such as confirming that the multifunction peripheral 1 is in a standby state ready to print.

However, if a print error command was not received from the multifunction peripheral 1 (S302: NO), then in S306 the CPU 21 determines whether a print complete command has been received from the multifunction peripheral 1. If a print complete command has not been received (S306: NO), then the CPU 21 returns to the process in S302. The print complete command is outputted from the multifunction peripheral 1 to the personal computer 20 when the multifunction peripheral 1 has completed a printing operation normally, and will be described later in greater detail.

If a print complete command has been received from the multifunction peripheral 1 (S306: YES), then in S308 the CPU 21 displays a message on the display panel 25, such as “Printing complete,” and ends the process. In this way, the user can be notified when the printing operation on the multifunction peripheral 1 has completed when the user is near the personal computer 20.

Through the process for commanding a direct print according to the embodiment, the personal computer 20 can specify image files 41 in the image card 40 to be printed by attaching the specification command “DPrint=Add” to the JPEG filenames of the image files 41 and transmitting the filenames to the multifunction peripheral 1. Therefore, the personal computer 20 need not read the image files 41 stored on the image card 40 in order to print the image files 41. Accordingly, the user can print image files 41 stored on the image card 40 quickly and easily.

FIG. 9 is a flowchart illustrating steps in a process for outputting thumbnail image data executed on the multifunction peripheral 1. This process is initiated when the multifunction peripheral 1 receives a list transmission request from the personal computer 20. When the multifunction peripheral 1 outputs requested image data through this process, the personal computer 20 can display the thumbnail images 30a or fixed images 30h symbolizing image files 41 stored on the image card 40 on the display panel 25.

Upon receiving a list transmission request from the personal computer 20, in S32 the CPU 2 of the multifunction peripheral 1 extracts filenames of files stored in the folder on the image card 40 corresponding to the folder icon 29a that was clicked in the thumbnail image display screen 28 and creates a list of these filenames. In S34 the CPU 2 transmits the created list of filenames to the personal computer 20 from which the list transmission request originated.

In S36 the CPU 2 waits until receiving either a reduced display command “Thumb=1” or a simplified display command “Thumb=2” attached to a JPEG filename. If the reduced display command “Thumb=1” or the simplified display command “Thumb=2” is received with the JPEG filename (S36: YES), then in S38 the CPU 2 reads the image file 41 corresponding to the received filename from the image card 40 based on the command.

In S40 the CPU 2 analyzes the data stored in a 103ff-byte (about 65 KB) region at the beginning of the image file 41 and determines whether the region holds thumbnail image data. The CPU 2 can determine whether the image file 41 holds thumbnail image data based on the type of data stored in the third and fourth bytes at the beginning of the file.

If the 103ff-byte region at the beginning of the image file 41 includes thumbnail image data (S40: YES), then in S42 the CPU 2 prepares the data stored in the 103ff-byte region at the beginning of the image file 41 for transmission to the personal computer 20. However, if the CPU 2 determines that this region does not include thumbnail image data (S40: NO), then in S46 the CPU 2 determines whether the command attached to the received filename is the simplified display command “Thumb=2”. If the simplified display command “Thumb=2” has been received (S46: YES), then in S48 the CPU 2 reads fixed image data from the fixed image data memory area 4b for image files 41 determined not to include thumbnail image data in the 103ff-byte region at the beginning thereof and prepares the fixed image data for transmission to the personal computer 20.

However, if the command attached to the received filename is not the simplified display command “Thumb=2” (S46: NO), in other words, if the reduced display command “Thumb=1” has been received, then in S50 the CPU 2 generates and prepares thumbnail image data for displaying the image file 41 at a reduced size based on the image file determined not to include thumbnail image data.

In S44 the CPU 2 determines whether all received JPEG filenames have been processed. If not all JPEG filenames have been processed (S44: NO), then the CPU 2 returns to the process in S38. However, if either thumbnail image data or fixed image data has been prepared for all image files 41 corresponding to the received JPEG filenames (S44: YES), then in S52 the CPU 2 transmits the prepared data to the personal computer 20 and ends the process.

By transmitting the thumbnail image data or fixed image data to the personal computer 20 according to the process for outputting thumbnail image data described above, the personal computer 20 can display thumbnail images 30a or fixed images 30h corresponding to the plurality of image files 41 stored on the image card 40. Since the data transmitted to the personal computer 20 is either thumbnail image data or fixed image data, a smaller amount of data is exchanged than when transmitting the plurality of image files 41 stored on the image card 40 to the personal computer 20 in their entirety, thereby reducing the time required for data communications. Hence, even if the multifunction peripheral 1 outputs data stored on the image card 40 via a network using the FTP protocol, the user can confirm the image files 41 on the image card 40 quickly and easily.

If the prescribed region at the beginning of the image file 41 does not include thumbnail image data when the simplified display command “Thumb=2” has been attached to the filename, the multifunction peripheral 1 transmits fixed image data stored in the ROM 4 in advance. Accordingly, the personal computer 20 can display thumbnail images 30a or fixed images 30h in a shorter amount of time that it takes to generate thumbnail image data, enabling the user to confirm the image files 41 stored on the image card 40 quickly and easily.

FIG. 10 is a flowchart illustrating steps in a process for executing a direct printing operation on the multifunction peripheral 1. The multifunction peripheral 1 performs the process for executing a direct printing operation at prescribed intervals when set to the photomedia capture mode.

At the beginning of this process in S60, the CPU 2 of the multifunction peripheral 1 determines whether a request to initialize the direct print function has been received. If this initialization request has not been received (S60: NO), then the CPU 2 ends the process.

However, when a request to initialize the direct print function has been received (S60: YES), then the request is separated into the filename “Status.txt” and the initialization command “DPrint=Clear” based on the separator “:”, as described above. Subsequently, in S62 the CPU 2 transmits the status file stored on the ROM 4 to the personal computer 20 based on the received filename “Status.txt” and in S64 clears the printing size memory area 3a, image quality memory area 3b, paper size memory area 3c, and specified file memory area 3d based on the initialization command “DPrint=Clear.”

In S66 the CPU 2 waits until direct print settings have been received from the personal computer 20. Upon receiving the direct print settings (S66: YES), the CPU 2 separates the settings into the filename “Status.txt” and the settings command “DPrint=Setting, . . . ,” which includes a description of the print settings, as described above in the request for initializing the direct print function. Subsequently, in S68 the multifunction peripheral 1 transmits the status file to the personal computer 20 based on the received filename “Status.txt” and in S70 stores the printing size, image quality, and paper size described in the settings command in the printing size memory area 3a, image quality memory area 3b, and paper size memory area 3c, respectively, based on the settings command “DPrint=Setting . . . .”

In S72 the CPU 2 determines whether a JPEG filename with the attached specification command “DPrint=Add” has been received from the personal computer 20. If the specification command “DPrint=Add” has been attached to the received JPEG filename (S72: YES), then in S74 the CPU 2 determines whether the image file 41 corresponding to the JPEG filename exists on the image card 40. If the image file 41 corresponding to the JPEG filename is on the image card 40 (S74: YES), i.e., if the received JPEG filename was transmitted from the multifunction peripheral 1 to the personal computer 20 in the process of S34 (see FIG. 9), then in S76 the CPU 2 reads the image file 41 corresponding to the JPEG filename from the image card 40 and stores the image file 41 in the specified file memory area 3d. Through this process, the CPU 2 reads the image files 41 indicated by a check in the checkboxes 30b of the thumbnail image display screen 28 from the image card 40 and stores the image files 41 in the specified file memory area 3d. However, if the specification command “DPrint=Add” has not been attached to the JPEG filename (S72: NO), then the CPU 2 skips S74, S76, and S78.

Further, if the image file 41 corresponding to the received filename does not exist in the image card 40 (S74: NO), then in S78 the CPU 2 transmits a response to the personal computer 20 indicating that the user-specified image file 41 does not exist on the image card 40.

In S80 the CPU 2 determines whether a request to initiate a direct printing operation has been received. If such a request has not been received (S80: NO), then the CPU 2 repeats the process from S72. After all filenames with the attached specification command “DPrint=Add” have been received from the personal computer 20 (S72: NO), and a request to initiate a direct printing operation is received (S80: YES), then in S82 the CPU 2 prints the image files 41 stored in the specified file memory area 3d with the printing device 6.

When the printing operation with the printing device 6 is completed successfully (S84: YES), in S86 the CPU 2 transmits a print complete command to the personal computer 20 and ends the process. If the printing operation on the printing device 6 was not completed successfully (S84: NO), then in S88 the CPU 2 transmits a print error command to the personal computer 20 and ends the process.

When the specification command “DPrint=Add” has been attached to a JPEG filename received during the process for executing a direct printing operation, the printing device 6 is controlled to print the image file 41 corresponding to this filename. Hence, even when the multifunction peripheral 1 outputs data stored in the image card 40 through a network employing the FTP protocol, the personal computer 20 does not need to read the image files 41 stored on the image card 40 in order to print the same. Accordingly, the user can print image files 41 on the image card 40 quickly and easily, even when issuing a print command from the personal computer 20.

While the invention has been described in detail with reference to the embodiment thereof, it would be apparent to those skilled in the art that various changes and modifications may be made therein without departing from the spirit of the invention.

For example, the FTP card reader 8 in the embodiment is incorporated in the multifunction peripheral 1. However, instead of the FTP card reader 8, it is possible to use a device functioning as a standalone card reader or card reader/writer.

Further, in the embodiment described above, 65 KB of data are outputted from the beginning of the JPEG image file. However, the multifunction peripheral 1 may be configured to output an amount of data less than or greater than 65 KB, provided that the data is outputted from a region including thumbnail image data.

Instead of “:”, at least one character and/or at least one symbol may be used as a separator that can be recognized by the FTP as a part of a filename and therefore that passes through the FTP, but that cannot be recognized as part of a filename by the FAT and therefore can be recognized as a separator for separating filename and command in the FAT.

Further, FAT is used as the file system in the embodiment, but the present invention may be applied to a configuration using the NTFS (NT File System) or other file system.

In the embodiment, the protocol for file transfers used by the LAN 50 is the file transfer protocol (FTP). However, the LAN 50 may use protocols other than FTP.

In the embodiment described above, upon receiving the list of filenames from the multifunction peripheral 1, the personal computer 20 analyzes the list to extract filenames for image files 41 of the JPEG format. However, the personal computer 20 may extract filenames for image files of any other desirable formats. The personal computer 20 attaches a command (reduced display command or simplified display command) to each of the extracted filenames, and transmits the filenames with the command attached to each to the multifunction peripheral 1. Upon receiving the command attached with filename, the multifunction peripheral 1 separates the filename and command. Based on the command separated from the filename, the multifunction peripheral 1 prepares data (thumbnail image data that is stored in a predetermined region of the image file specified by the filename for each specified image file), generates thumbnail image data, or prepares icon data. That is, when the thumbnail image data is stored in the predetermined region of the image file, the multifunction peripheral 1 outputs a proper amount of data from the predetermined region of the image file that includes the thumbnail image data. The predetermined region may be defined at the beginning of the image file, or may be defined at another area of the image file. The multifunction peripheral 1 outputs this prepared data to the personal computer 20. Upon receiving this data from the multifunction peripheral 1, the personal computer 20 displays corresponding images in the thumbnail image display region 30 based on the received data.

What is claimed is:

1. An image displaying system, comprising:
a removable media device that is configured to be capable of reading data stored on removable medium; and
an image processor that is connected to the removable media device via a network and that is configured to be capable of displaying images based on inputted data, the image processor being capable of performing data communications with the removable media device via the network,
the removable media device comprising:
a filename receiving unit receiving a filename of an image file stored on removable medium from the image processor;
a reduced data determining unit determining whether an image file with the filename received by the filename receiving unit has reduced data in a prescribed region of the image file for displaying the image file at a reduced size when a prescribed reduced display command is attached to the filename;
a reduced data generating unit generating reduced data based on the image file in order to display the image file at a reduced size when the reduced data determining unit determines that the reduced data is not included in the prescribed region of the image file; and
a data transmitting unit transmitting either the reduced data generated by the reduced data generating unit or the reduced data included in the prescribed region of the image file to the image processor for each image file,
the image processor including a display unit displaying the reduced data for each image file.

2. An image displaying system according to claim 1, wherein the reduced data determining unit determines whether or not the prescribed region of the image file corresponding to the filename includes reduced data when a prescribed simplified display command has been attached to the filename received by the filename receiving unit; and
the data transmitting unit transmits reduced data to the image processor for an image file that the reduced data determining unit determines to have reduced data in the prescribed region, but transmits prescribed icon data to the image processor for an image file that the reduced data determining unit determines not to have reduced data in the prescribed region,
the display unit displaying the reduced data or the icon data transmitted from the removable media device.

3. An image displaying system according to claim 1, wherein the filename receiving unit receives a filename that has a character or a symbol which passes through the network as part of the filename, and which is recognized in a file system used by the removable media device not as part of the filename but as a separator for separating the filename and command.

4. An image displaying system according to claim 3, wherein the filename receiving unit receives a filename with “:” attached as the separator.

5. An image displaying system according to claim 4, wherein the file system used on the removable media device is configured of the File Allocation Table (FAT).

6. An image printing system, comprising:
a removable media device; and
an image processor that is capable of data communications with the removable media device via a network,
the removable media device comprising:
a printing unit configured capable of printing an image file stored on removable medium;
a filename transmitting unit transmitting at least one filename of at least one image file stored on the removable medium to the image processor; and
a filename receiving unit receiving at least one filename from the image processor that is among the at least one filename that has been transmitted to the image processor by the filename transmitting unit, the printing unit printing an image file corresponding to each of the received filename when a prescribed specification command is attached to the each filename.

7. An image printing system according to claim 6, wherein the filename receiving unit receives a filename that has a character or a symbol which passes through the network as part of the filename, and which is recognized in a file system used by the removable media device not as part of the filename but as a separator for separating the filename and command.

8. An image printing system according to claim 7, wherein the filename receiving unit receives a filename with “:” attached as the separator.

9. An image printing system according to claim 8, wherein the file system used on the removable media device is configured of the File Allocation Table (FAT).

10. A removable media device for reading data stored on removable medium, the removable media device comprising:
a filename receiving unit receiving a filename of an image file stored on removable medium from the image processor;
a reduced data determining unit determining whether an image file with the filename received by the filename receiving unit has reduced data in a prescribed region of the image file for displaying the image file at a reduced size when a prescribed reduced display command is attached to the filename;
a reduced data generating unit generating reduced data based on the image file in order to display the image file at a reduced size when the reduced data determining unit determines that the reduced data is not included in the prescribed region of the image file; and
a data outputting unit outputting either the reduced data generated by the reduced data generating unit or the reduced data included in the prescribed region of the image file for each image file.

11. A removable media device according to claim 10, wherein the reduced data determining unit determines whether or not the prescribed region of the image file corresponding to the filename includes reduced data when a prescribed simplified display command has been attached to the filename received by the filename receiving unit; and
the data outputting unit outputs reduced data for an image file that the reduced data determining unit determines to have reduced data in the prescribed region, but outputs prescribed icon data for an image file that the reduced data determining unit determines not to have reduced data in the prescribed region.

12. A removable media device according to claim 10, wherein the filename receiving unit receives, via a network, a filename that has a character or a symbol which passes through the network as part of the filename, and which is recognized in a file system used by the removable media device not as part of the filename but as a separator for separating the filename and command.

13. A removable media device according to claim 12, wherein the filename receiving unit receives a filename with “:” attached as the separator.

14. A removable media device according to claim 13, wherein the file system used on the removable media device is configured of the File Allocation Table (FAT).

15. A removable media device, comprising:
a printing unit configured capable of printing an image file stored on removable medium;
a filename outputting unit outputting at least one filename of at least one image file stored on the removable medium; and
a filename receiving unit receiving at least one filename that is among the at least one filename that has been outputted by the filename outputting unit, the printing unit printing an image file corresponding to each of the received filename when a prescribed specification command is attached to the each filename.

16. A removable media device according to claim 15, wherein the filename receiving unit receives, via a network, a filename that has a character or a symbol which passes through the network as part of the filename, and which is recognized in a file system used by the removable media device not as part of the filename but as a separator for separating the filename and command.

17. A removable media device according to claim 16, wherein the filename receiving unit receives a filename with “:” attached as the separator.

18. A removable media device according to claim 17, wherein the file system used on the removable media device is configured of the File Allocation Table (FAT).

19. A data control method implemented on an image displaying system including an image processor and a removable media device connected with each other via a network, the image processor being capable of performing data communications with the removable media device via the network, the removable media device being capable of reading data stored on removable medium, the image processor being capable of displaying images on a screen based on data inputted from the removable media device, the data control method comprising:
controlling the image processor to select either a reduced data request command or a simplified data request command based on user settings,
the reduced data request command serving as a request for reduced data in a prescribed region of an image file in order to display the image file at a reduced size when the reduced data is included in the prescribed region and serving as a request for reduced data generated by the removable media device based on the image file when the image file does not include the reduced data,
the simplified data display command serving as a request for reduced data when the reduced data is included in the prescribed region of the image file and serving as a request for prescribed icon data indicating the image file when the image file does not include the reduced data;
controlling the image processor to acquire filename for each of at least one image file stored on the removable medium;
controlling the image processor to transmit the acquired at least one filename after attaching the selected command to each of the acquired at least one filename; and
controlling the image processor to perform either one of a first display operation and a second display operation,
the first display operation being for displaying on one screen at least one reduced image for at least one image file corresponding to the transmitted at least one filename using data transmitted from the removable media device in response to the reduced data request command,
the second display operation being for displaying on one screen at least one image for the at least one image file corresponding to the transmitted at least one filename using data transmitted from the removable media device in response to the simplified data request command, the image for each image file being either one of a reduced image for the corresponding image file and a prescribed icon indicating the corresponding image file.

20. A data control method according to claim 19, wherein, in the filename transmitting step, the image processor attaches a character or symbol that passes as part of a filename in the network and that is recognized in the file system used on the removable media device not as part of a filename but as a separator for separating the filename and command, and transmits the filename with the attached command to the removable media device.

21. A data control method according to claim 20, wherein, in the filename transmitting step, the image processor attaches “:” as the separator.

22. A data control method according to claim 21, wherein the file system used on the removable media device is configured of FAT.

23. A data control method implemented on an image printing system including an image processor and a removable media device connected with each other via a network, the image processor being capable of performing data communications with the removable media device via the network, the removable media device comprising a printing unit printing image files stored on removable medium, the data control method comprising:
controlling the image processor to acquire filename for an image file stored on a removable medium; and
controlling the image processor to attach a prescribed specification command to the acquired filename and to transmit the filename to the removable media device, thereby causing the removable media device to control the printing unit to print an image file corresponding to the filename to which the specification command is attached.

24. A data control method according to claim 23, wherein, in the filename transmitting step, the image processor attaches a character or symbol that passes as part of a filename in the network and that is recognized in the file system used on the removable media device not as part of a filename but as a separator for separating the filename and command, and transmits the filename with the attached command to the removable media device.

25. A data control method according to claim 24, wherein, in the filename transmitting step, the image processor attaches “:” as the separator.

26. A data control method according to claim 25, wherein the file system used on the removable media device is configured of FAT.

27. A data control method implemented on an image processor that is capable of displaying images on a screen based on inputted data, the data control method comprising:
selecting either a reduced data request command or a simplified data request command based on user settings,
the reduced data request command serving as a request for reduced data in a prescribed region of an image file in order to display the image file at a reduced size when the reduced data is included in the prescribed region and serving as a request for reduced data generated based on the image file when the image file does not include the reduced data,
the simplified data display command serving as a request for reduced data when the reduced data is included in the prescribed region of the image file and serving as a request for prescribed icon data indicating the image file when the image file does not include the reduced data;
acquiring filename for each of at least one image file stored on the removable medium;
outputting the acquired at least one filename after attaching the selected command to each of the acquired at least one filename; and
performing either one of a first display operation and a second display operation,
the first display operation being for displaying on one screen at least one reduced image for at least one image file corresponding to the outputted at least one filename using data received in response to the reduced data request command,
the second display operation being for displaying on one screen at least one image for the at least one image file corresponding to the outputted at least one filename using data received in response to the simplified data request command, the image for each image file being either one of a reduced image for the corresponding image file and a prescribed icon indicating the corresponding image file.

28. A data control method according to claim 27, wherein, in the filename outputting step, the image processor attaches, as a separator for separating the filename and command, a character or symbol that passes as part of a filename in a network connected to the image processor, and outputs the filename with the attached command to the network.

29. A data control method according to claim 28, wherein, in the filename outputting step, the image processor attaches “:” as the separator.

30. A data control method implemented on an image processor, the data control method comprising:
acquiring filename for an image file stored on a removable medium; and
attaching a prescribed specification command to the acquired filename and outputting the filename.

31. A data control method according to claim 30, wherein, in the filename outputting step, the image processor attaches, as a separator for separating the filename and command, a character or symbol that passes as part of a filename in a network connected to the image processor, and outputs the filename with the attached command to the network.

32. A data control method according to claim 31, wherein, in the filename outputting step, the image processor attaches “:” as the separator.

33. A storage medium storing a set of program instructions executable on an image processor that is capable of displaying images on a screen based on inputted data, the instructions comprising:
selecting either a reduced data request command or a simplified data request command based on user settings,
the reduced data request command serving as a request for reduced data in a prescribed region of an image file in order to display the image file at a reduced size when the reduced data is included in the prescribed region and serving as a request for reduced data generated based on the image file when the image file does not include the reduced data,
the simplified data display command serving as a request for reduced data when the reduced data is included in the prescribed region of the image file and serving as a request for prescribed icon data indicating the image file when the image file does not include the reduced data;
acquiring filename for each of at least one image file stored on the removable medium;
outputting the acquired at least one filename after attaching the selected command to each of the acquired at least one filename; and
performing either one of a first display operation and a second display operation,
the first display operation being for displaying on one screen at least one reduced image for at least one image file corresponding to the outputted at least one filename using data received in response to the reduced data request command,
the second display operation being for displaying on one screen at least one image for the at least one image file corresponding to the outputted at least one filename using data received in response to the simplified data request command, the image for each image file being either one of a reduced image for the corresponding image file and a prescribed icon indicating the corresponding image file.

34. A storage medium storing a set of program instructions executable on an image processor, the instructions comprising:
acquiring filename for an image file stored on a removable medium; and
attaching a prescribed specification command to the acquired filename and outputting the filename.
